(19) United States
(12) Patent Application Publication
(10) Pub. No.: US 2018/0158151 A1
(43) Pub. Date: Jun. 7, 2018

(54) MANAGING VOLATILITY RISK IN VARIABLE PRICED UTILITIES

(71) Applicant: Power Club Investments Pty Ltd, Orange, New South Wales (AU)

(72) Inventor: Graeme Stuart MCPHERSON, Orange, New South Wales (AU)

(21) Appl. No.: 15/578,118

(22) PCT Filed: May 29, 2016
(86) PCT No.: PCT/IB2016/053167

§ 371 Date: Nov. 29, 2017

(30) Foreign Application Priority Data
May 29, 2015 (AU) 2015902013

(51) Int. Cl. G06Q 50/06; G06Q 20/14; G06Q 30/04

(52) U.S. Cl. CPC G06Q 50/06; G06Q 30/04; G06Q 20/14

(57) ABSTRACT

A method comprising the steps performed by a specially programmed computer of: receiving a predicted usage by customers of a utility having fixed costs and variable usage prices; establishing a fund for hedging volatility risk in the variable usage prices by combining contributions from the customers based on the predicted usage and a volatility margin to offset the volatility risk; determining a fixed, predicted usage price for the customers based on historic variable usage prices, forecast variable usage prices, or a combination thereof.

### PRIORITY CLAIM

The present application is a national stage entry of International Application No. PCT/162016/053167, filed on May 29, 2016, which claims priority to Australian Patent Application Number 2015902013 filed May 29, 2015. The entire disclosure of each of these applications is incorporated by reference herein.

### FIELD

The present invention relates to managing volatility risk in variable priced utilities.

### BACKGROUND

Utilities such as electricity, gas, water, sewage, etc were historically regulated and supplied under cost-based tariffs with retail prices set on a cost-plus, fixed-return basis. The shift to competitive markets for supplying utilities has required a more free-market approach that has resulted in usage-based, variable pricing structures. For example, there is a high volatility or variability in the wholesale variable usage prices of electricity over both time and location due to technical factors such as variation in demand, congestion in transmission networks, and location of electricity generation capacity.

Existing approaches to managing financial risk in utilities suffer from various drawbacks. They are based on conventional financial risk management instruments, such as forward and futures contracts, cap contracts, price swaps, and options contracts. Financial risk management instruments have significant establishment and management costs. They are also generally only available to large wholesale utility consumers, not retail consumers. Further, existing retail pricing structures for the supply of utilities, such as electricity, comprise cost stacks of both usage-based, variable costs and fixed costs, such as infrastructure charges, operating charges, and regulatory charges. These complicated cost stacks mask the high volatility in the variable usage pricing of the utility, and therefore prevent retail consumers from hedging their exposure to volatility risk associated with the utility.

In this context, there is a need for improved solutions for managing volatility risk in variable priced utilities.

### SUMMARY

According to the present invention, there is provided a method comprising the steps performed by a specially programmed computer of:

receiving a predicted usage by customers of a utility having fixed costs and variable usage prices;

establishing a fund for hedging future volatility risk in the variable usage prices by combining prepaid contributions from the customers based on the predicted usage and a volatility margin to offset the volatility risk;

determining a fixed, predicted usage price for the customers based on historic variable usage prices, forecast variable usage prices, or a combination thereof.

The method may further comprise the steps of:

receiving wholesale cost stacks for the customers comprising the fixed costs, and actual variable costs based on actual usage by the customers and actual variable usage prices of the utility;

unstacking the wholesale cost stacks to separate the actual variable costs from the fixed costs;

creating retail bills for the customers comprising the fixed costs, and predicted variable costs based on actual usage by the customers and the predicted usage price of the utility;

receiving retail bill payments for the retail bills comprising fixed cost payments and predicted variable cost payments.

The method may further comprise the steps of:

paying the predicted variable cost payments in full into the fund;

paying the actual variable costs in full from the fund.

The method may further comprise the step of paying the fixed costs in full from the fixed cost payments not paid into the fund.

Alternatively, the method may further comprise the steps of:

if the actual variable costs are greater than the predicted variable costs, paying the actual variable costs in part from the predicted variable cost payments, and paying remaining balances of the actual variable costs from the fund;

if the actual variable costs are less than the predicted variable costs, paying the actual variable costs in full from the predicted variable cost payments, and paying remaining balances of the predicted variable cost payments into the fund.

The utility may comprise electricity, gas or a combination thereof.

The method may be provided to the customers as software-as-a-service.

The method may further comprise the step of receiving membership fees from the customers to participate in the fund.

The present invention also provides a non-transitory computer-readable medium comprising computer-readable instructions, wherein execution of the computer-readable instructions by a computer causes the computer to:

receive a predicted usage by customers of a utility having fixed costs and variable usage prices;

establish a fund for hedging future volatility risk in the variable usage prices by combining prepaid contributions from the customers based on the predicted usage and a volatility margin to offset the volatility risk;

determine a fixed, predicted usage price for the customers based on historic variable usage prices, forecast variable usage prices, or a combination thereof.

The computer-readable instructions may further cause the computer to:

receive wholesale cost stacks for the customers comprising the fixed costs, and actual variable costs based on actual usage by the customers and actual variable usage prices of the utility;

unstack the wholesale cost stacks to separate the actual variable costs from the fixed costs;

create retail bills for the customers comprising the fixed costs, and predicted variable costs based on actual usage by the customers and the predicted usage price of the utility;

receive retail bill payments for the retail bills comprising fixed cost payments and predicted variable cost payments.

The computer-readable instructions may further cause the computer to:

pay the predicted variable cost payments in full into the fund;

pay the actual variable costs in full from the fund.

The computer-readable instructions may further cause the computer to pay the fixed costs in full from the fixed cost payments not paid into the fund.

Alternatively, the computer-readable instructions may further cause the computer to:

if the actual variable costs are greater than the predicted variable costs, pay the actual variable costs in part from the predicted variable cost payments, and pay remaining balances of the actual variable costs from the fund;

if the actual variable costs are less than the predicted variable costs, pay the actual variable costs in full from the predicted variable cost payments, and pay remaining balances of the predicted variable cost payments into the fund.

### BRIEF DESCRIPTION OF DRAWINGS

Embodiments of the invention will now be described by way of example only with reference to the accompanying drawings, in which:

FIG. 1 is a block diagram of a computer system for managing volatility risk in variable priced utilities according to an embodiment of the present invention;

FIG. 2 is a flowchart of a method implemented by the computer system;

FIG. 3 is a schematic diagram of an example retail electricity supply market;

FIGS. 4 to 12 are example use cases of the method; and

FIG. 13 is a swimlane diagram of the method.

### DETAILED DESCRIPTION

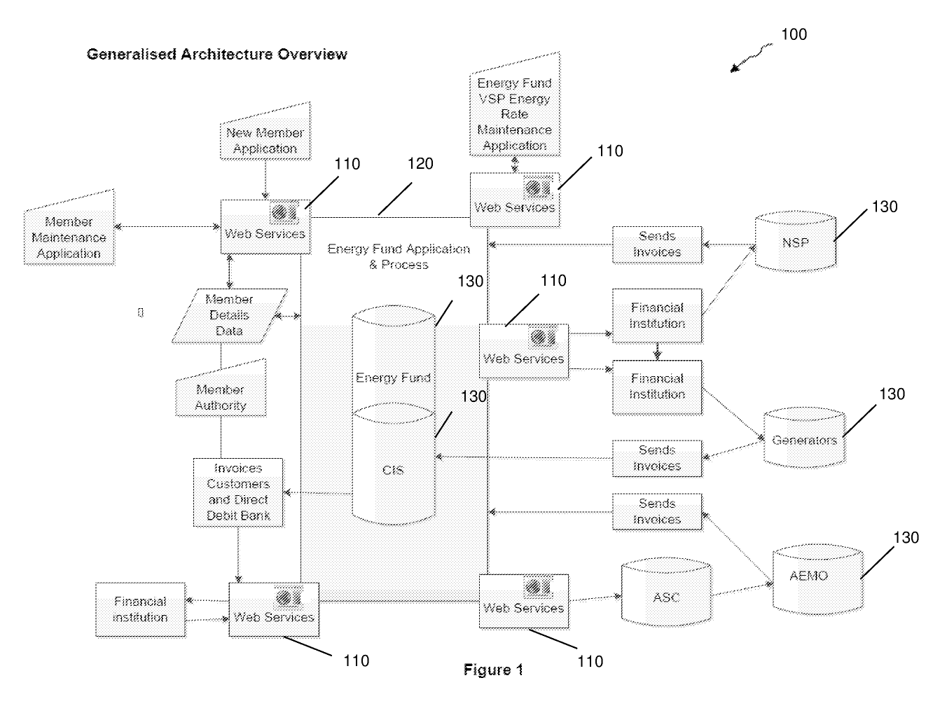

FIG. 1 is a block diagram of a computer system 100 for implementing a method 200 for managing volatility risk in variable priced utilities according to an embodiment of the present invention. The utilities may comprise any and all utilities having fixed costs and usage-based, variable pricing, such as electricity, gas or a combination thereof. The system 100 may generally comprise one or more specially programmed computers that execute computer-readable instructions to perform the steps of the method 200. The one or more specially programmed computers of the system 100 may comprise one or more clients 110 connected via a network to one or more application servers 120. The application servers 120 may be associated with one or more databases 130. The clients 110 may comprise smartphones, tablets, laptop computers, desktop computers, and combinations thereof. The application servers 120 and associated databases 130 may comprise cloud servers, cloud data storages, and combinations thereof.

The application servers 120 may be configured to implement web and/or mobile applications that provide web and/or mobile services to the client devices 110 for managing volatility risk in variable priced utilities. The web and/or mobile services provides by the application server software may comprise services relating to registering customers, managing volatility risk, billing, and processing electronic payments. The web and/or mobile applications may provide the services as software-as-a-service (SaaS) services to subscribers. The subscribers to the SaaS may comprise customers who use the utility, such as retail utility customers. The web and/or mobile applications may also provide application programming interfaces (APIs) to interface with other web and/or mobile applications or data stores associated with, or used by, utility generators, utility wholesalers, utility resellers, utility suppliers, utility network or infrastructure providers, utility regulators, financial institutions, etc.

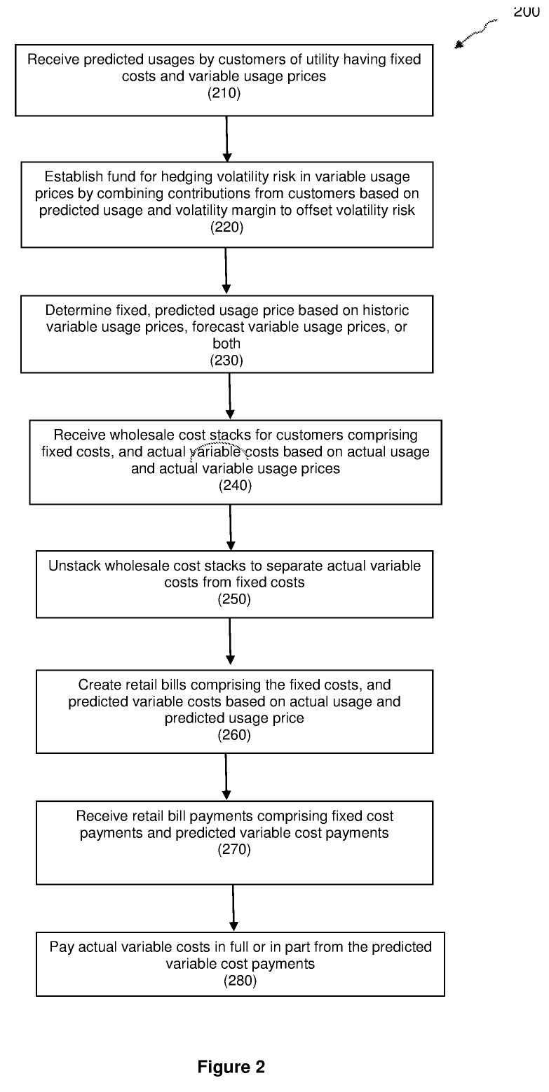

FIG. 2 is flowchart of a method 200 implemented by the computer system 100. The method 200 starts by receiving predicted usages from individual customers of a utility having fixed costs and variable usage prices that are characterised by volatility and variability, either in time or geography (210). The utility may comprise, for example, electricity, gas or a combination thereof. For example, when the utility is electricity, the predicted usage may be predicted usage over a utility billing period, such as an annual predicted usage, expressed in kilowatts hours (KWh).

Next, a fund for hedging volatility risk in the variable usage prices of the utility for the customers may be established by combining contributions from the customers based on their predicted usage and a volatility margin to offset the volatility risk (220). As used herein, volatility risk is the financial risk associated with changes in the usage-based, variable pricing of the utility due to volatility and variability in supply and demand of the utility, either in time or geography. The provider and manager of the fund may act as a retailer or reseller of the utility from wholesale suppliers or providers of the utility. The customers may be retail customers of the fund manager. The fund manager may be the provider of the application server 120. To hedge the volatility risk for the retail customers, a wholesale, fixed predicted usage price of the utility over the utility billing period may also be determined by the fund manager based, for example, on historic variable usage prices, forecast variable usage prices or a combination thereof (230). The establishment of the fund and the fixing of the predicted usage price of the utility may enable the retail customers to purchase the utility at a hedged, fixed price for the utility billing period.

Wholesale cost stacks for the customers may be received by the fund manager from utility wholesalers (240) for the utility billing period, for example, on a monthly billing cycle. The wholesale cost stacks may comprise the fixed costs associated with the utility, and actual variable costs based on actual usage by the customers over the billing period, and actual variable prices of the utility during the billing period. Where an actual usage is not available, for example if an actual utility meter reading has not been performed, an estimated actual usage may be used. The fixed costs may comprise, for example, fixed costs associated with distribution, operation, and regulation of the utility, such as infrastructure costs, operating costs, regulatory costs, and combinations thereof. For example, when the utility is electricity, the fixed costs may comprise environmental scheme charges, renewable energy scheme charges, retail margin charges, retail operating charges, feed-in tariff charges, distribution network charges, transmission network charges, carbon charges, and combinations thereof.

Next, the wholesale cost stacks may be unstacked by the fund manager to separate the actual variable costs of the customers from their fixed costs (250). The fund manager may then create retail bills for the customers for the corresponding billing period. The retail bills may comprise the fixed costs, and predicted variable costs based on actual usage by the customers and the predicted price of the utility (260). The retail bills may be presented to the customers by the fund manager, and retail bill payments for the retail bills may be received by the fund manager from the customers (270). The retail bill payments may be allocated, segmented or separated into fixed cost payments and predicted variable cost payments. After receipt, the predicted variable cost payments may be allocated, either in full or in part, to pay the actual variable costs (280) according to alternative first and second payment allocation sub-methods described below. The fixed cost payments may not be paid into the fund at any stage, but may instead be paid directly from the fixed cost payments.

In the first sub-method, the fund manager may pay the predicted variable cost payments in full into the fund (280). The actual variable costs may then be paid in full from the fund (290). In other words, in this first financial allocation process, the predicted variable cost payments may be credited in full to the fund, and the actual variable costs may be debited in full from the fund. Any differences between the actual and predicted variable costs of the customers due to volatility risk may be hedged by the volatility margin included in the customer contributions used to establish the fund.

In the alternative second sub-method, if the actual variable costs are greater than the predicted variable costs, the fund manager may pay the actual variable costs in part from the predicted variable cost payments, and remaining balances of the actual variable costs may be paid from the fund. Alternatively, if the actual variable costs are less than the predicted variable costs, the fund manager may pay the actual variable costs in full from the predicted variable cost payments, and pay remaining balances of the predicted variable cost payments into the fund.

The invention will now be described in more detail, by way of illustration only, with respect to the following example. The example is intended to serve to illustrate this invention, and should not be construed as limiting the generality of the disclosure of the description throughout this specification.

### Example: Electricity

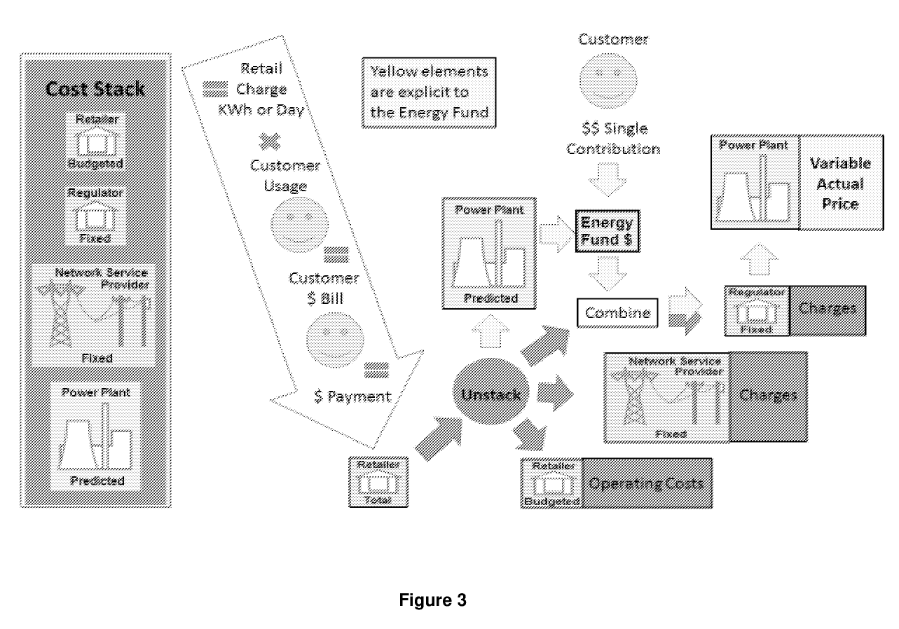

FIG. 3 is a simplified schematic diagram of retail electricity supply in Australia. In this example, the following abbreviations and definitions are used.
AEMO Australian Energy Market Operator Average Cost historical or current average cost
CIS Customer Information System for recording all customer financial and general information as part of customer management and billing
CS Cost Stack, see Stack/s
Energy Fund or Prepayment pool, Buffer fund, System 100 and method 200 whose purpose is to accommodate price volatility
MWh Megawatt hour
NEM National Energy Market (Australian)
NSP Network Service Provider
Over Cost potential or actual additional cost arising out of cost volatility and other factors compared to the average or anticipated cost
Prepayment pool or Energy Fund, Buffer fund, System 100 and method 200 whose purpose is to accommodate price volatility
Prepayment or Pool Prepayment: a contribution made to the Prepayment pool by a customer in proportion to their annual consumption of the Utility product and the risk estimated to be supported by the Prepayment pool
Raw Energy is the energy only component of wholesale energy cost which, when invoiced, may include additional regulatory and other costs
RE Regulation Entity, in the NEM this is the Australian Energy Market Operator (AEMO)
Server One or more single server or virtual server or the like required to complete processing related to Energy Fund
Stack/s is a bundle of individual cost elements that make up the overall single unit charge potentially payable by a customer in relation to a billing period, and where each element may be defined, tracked and allocated by the retailer as the retailer sees fit
Utility or Candidate Utility, historically a regulated commodity supplied under cost-based tariffs with retail prices set on a cost-plus fixed-return basis and now provided through a retailer buying the commodity in a competitive market place
Variable cost A supply whose unit cost in a wholesale market is dynamic and volatile in time frames less than those of interest to the consumer. It does not mean a cost variation arising out of higher or lower units of consumption by a consumer.
VESC Victorian Essential Services Commission

Electricity is typically provided to consumers by retailers at an agreed price for a period of time. The volatility in the price of supply to the retailer can be significant in time frames that are shorter than those over which payment by the consumer was agreed. This is particularly the case in respect of the supply of electrical energy (or electricity). In Australia, electricity is provided to the market, and then to consumers, through a real time system managed by the AEMO.

Consumers typically contract to buy power from a retailer for a fixed price either as a contact for a significant period of time, or an implied contract for the duration of the billing period (typically at least 1 month). As part of the fixed price, the retailer will be including their forward estimate of the cost of energy acquisition at, for example, $40 per MWh, however, the actual cost of that energy to the retailer may vary, for example, between minus $1,000/MWh to plus $13,500 MWh. This situation arises as a natural, albeit regulated, outcome of a price for supply that is determined by a bidding process for every five-minute period of energy provided to the power grid. The difference between that cost and what the retailer is contracted to receive from the consumer is a market price risk that the retailer has to manage.

For example, in Australia, the retailer is generally not permitted to take a security deposit from the consumer or to hold some sort of bond to secure payment for what has been supplied. The retailer must also have enough funds at the end of each period to cover any market loss that might occur in that period. Even for a small retailer this loss could amount to millions of dollars. Any inability by the retailer to make payment the moment it falls due will result in the instant and automatic transfer of that retailer's customers to a retailer of last resort and the original retailer is then out of business.

The solutions used by existing retailers in the market typically involve a mix of one or more of, in-house funds accumulated over time, electricity futures contracts on the ASX, cap contracts, standing contracts with energy generators for “power cover” in periods where it would otherwise be very expensive and other such measures.

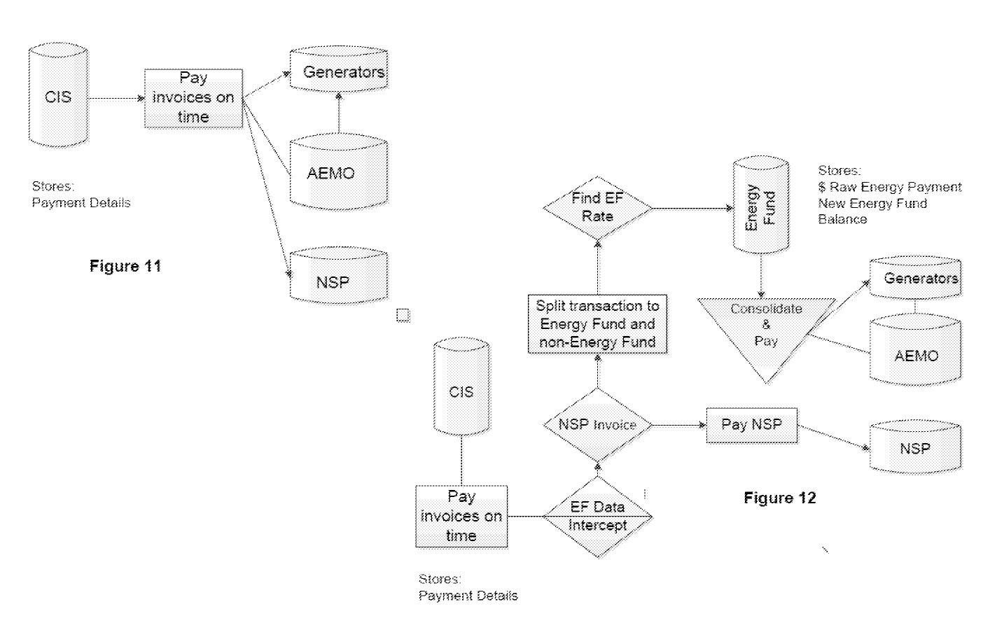

In light of the above factors and considerations, the Energy Fund may optimise the supply of retail electricity by hedging risk associated with variable priced wholesale supply of electricity. The Energy Fund enables retail customers to manage the risk associated with buying electrical energy at variable wholesale prices. The Energy Fund provides web and/or mobile services to register members of the Energy Fund, process prepayments and membership fees by members to the prepayment pool, unstack retail cost stacks to enable payment of suppliers and process electronic payments of variable price based supplies from the prepayment pool. FIG. 6 (new user, establish prepayment pool), FIG. 10 (user payment receipt) and FIG. 12 (supplier payment process) illustrate example use cases of the web and/or mobile services provided by the Energy Fund.

Referring to FIG. 3, the basic components of a cost stack of a retail energy bill to a customer is typically comprised of retailer budgeted costs, regulator fixed costs, network service provider costs, and power plant predicted costs (either direct or indirectly through the energy market managed by the AEMO). The schematic in FIG. 3 is simplified because in practice a single bill to a single retail customer may contain many cost stacks, and those cost stacks could potentially be across two time frames, which would double the number of cost stacks in the bill. Bill payment is conventional, but on receipt of payment the bill must be unstacked to enable the predicted energy component to be transferred to the customer-sponsored Energy Fund. Adjustments may also need to be made to take account of or offset consumer related energy supply inputs, for example, electricity provided by the consumer from on-site solar and/or battery power systems. The Energy Fund is then used to pay the actual price for the energy acquired on behalf of the retail customer. This value is combined with the standard fixed charges to pay the bill in full. This process maintains a balance in the customer-sponsored Energy Fund that reflects the difference between the predicted energy cost and the actual energy cost, while protecting and isolating the customers interest in the Energy Fund.

The structure and processes illustrated in FIGS. 6, 10, 12 and 13 isolate and protect the Energy Fund from risk of direct financial involvement in general retailer business costs, margins and other costs unrelated to the acquisition of wholesale energy for the retail customer. The variable priced supply portion of the cost stack in the bill is applied to the Energy Fund for payment and risk management of the variable price based supply.

To ensure the initial volatility risk management payment by the retail customer is sufficient in a volatile market there may be significant calculation of the possible “over cost”, for the acquisition of energy to be supplied to consumers in the period ahead (typically a year). The “over cost” is any significant increase, above the usual range in prices, that could arise out of one or more rare events in the period of interest ahead (typically one or more years). The calculation of “average cost” and “over cost” may be made using conventional statistical techniques using historical and other data. Such techniques typically involve the use of means and standard deviations to evaluate the probabilities for energy prices over time, on the assumption that the variation of such prices is distributed in a recognized way. One option is for the use of those relationships that are associated with a normal distribution, however it is the case that energy prices may not be normally distributed and a more accurate determination of the allowance to be made for “market risk” might be made using other statistical techniques, including step, frequency and reversion analysis.

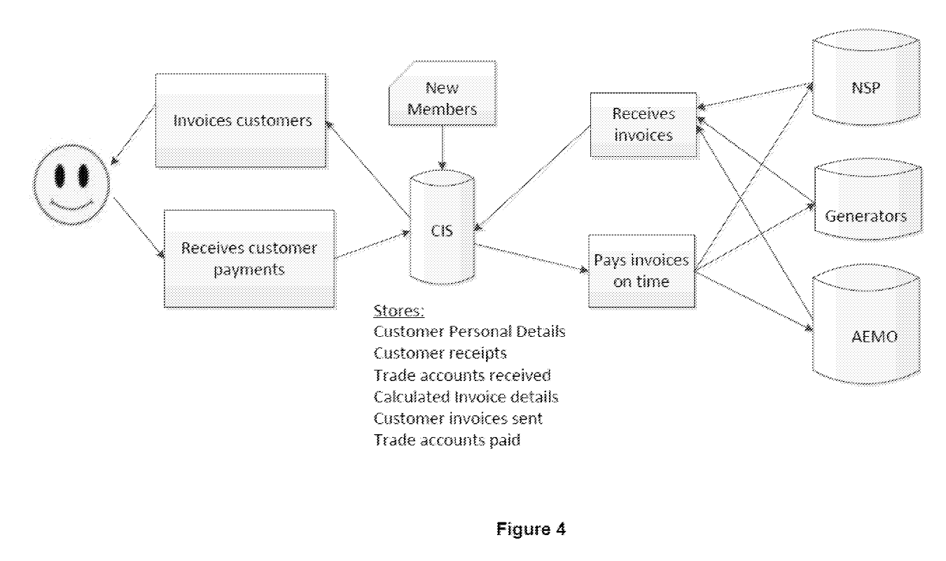

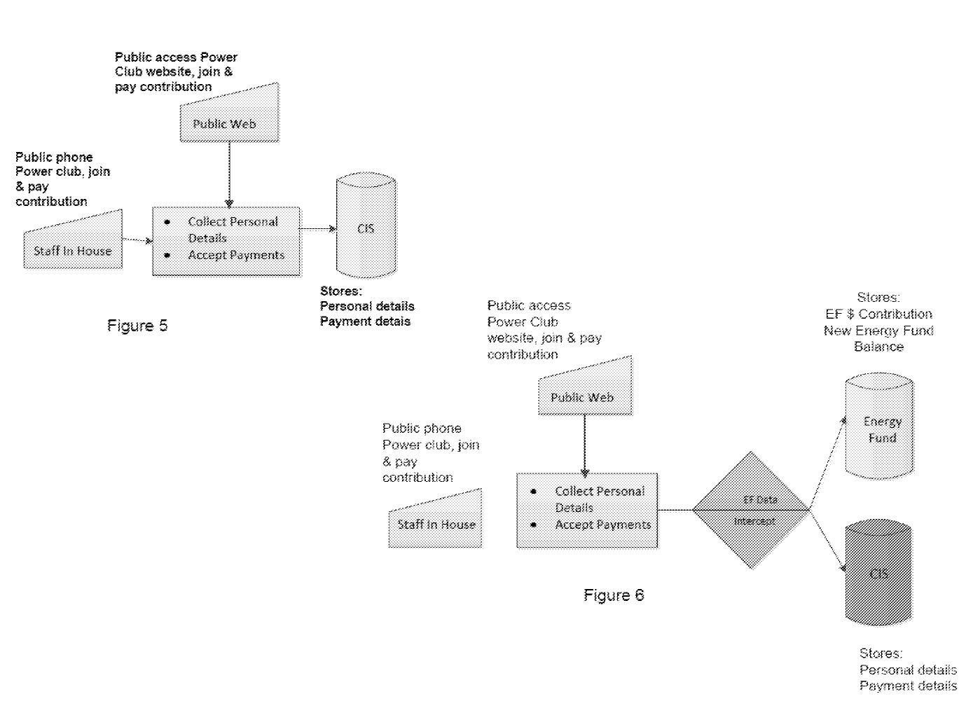

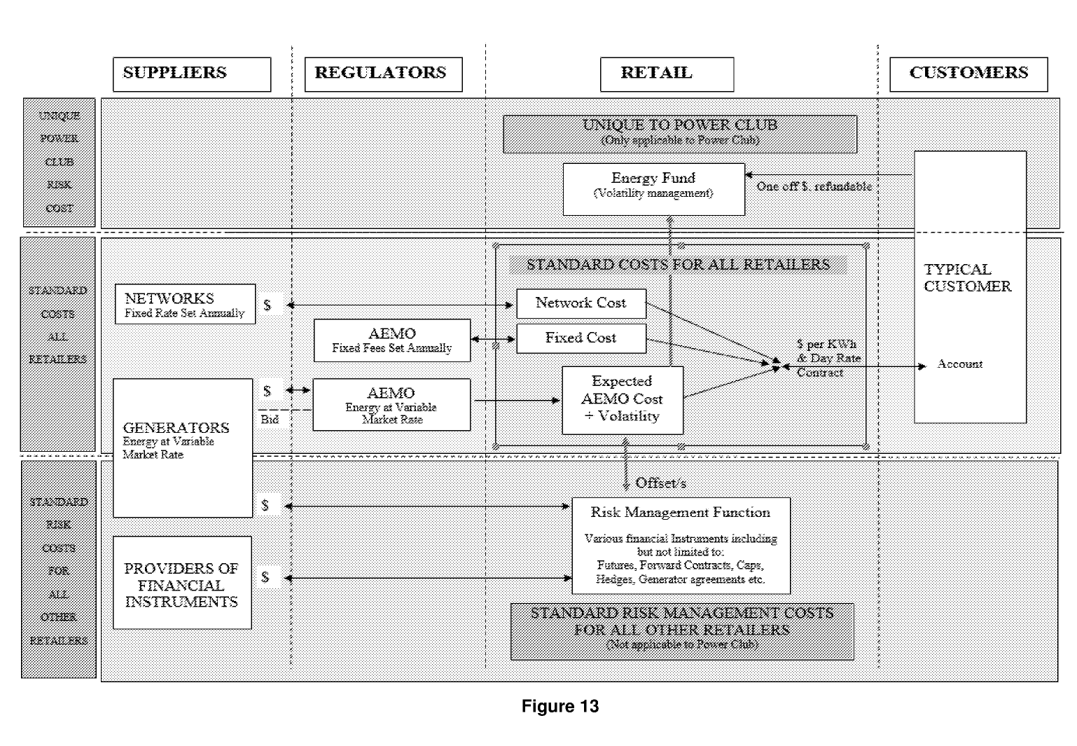

FIGS. 4 to 12 illustrate example use cases that highlight the differences between the Energy Fund process and the conventional process for retail electricity supply. FIG. 13 is a swimlane diagram illustrating respective responsibilities and actions of the Energy Fund provider and other conventional participants in the electricity supply chain. Referring to FIGS. 5 and 6, in a conventional New Customer process there is no Energy Fund Volatility risk management payment component. On receipt of the transaction the Energy Fund Application must intercept the transaction and extract any relevant part of the payment supporting the Energy Fund and place it in the prepayment pool of the Energy Fund.

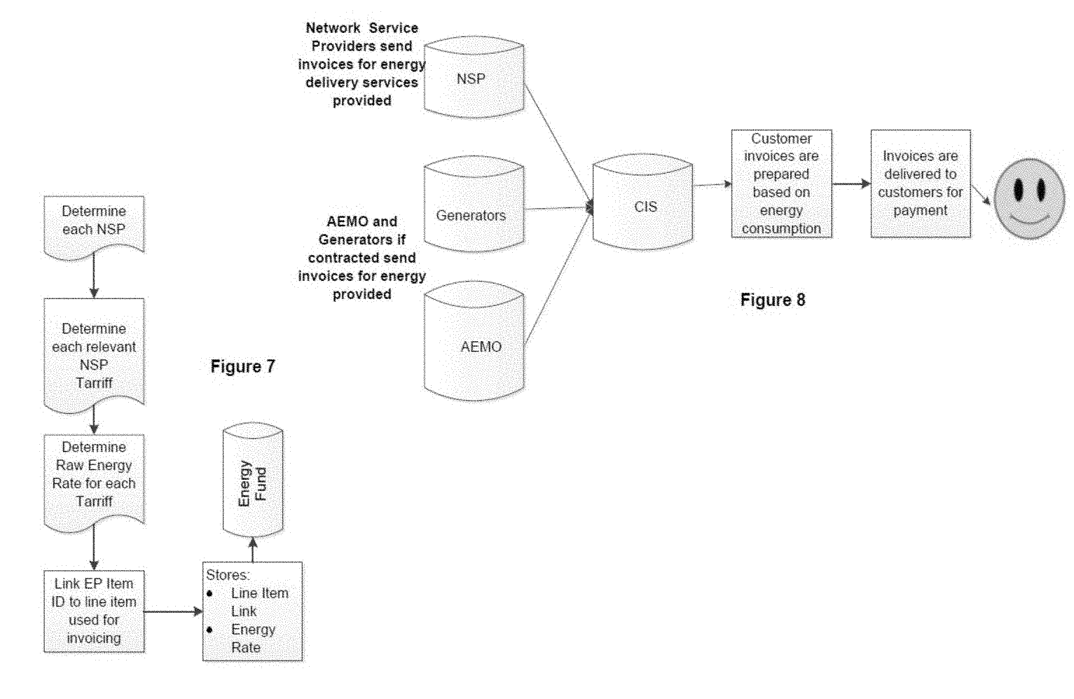

Referring to FIG. 7, to enable the Energy Fund application to intercept and successfully process energy payments received from members in payment of their total energy bill requires an Energy Fund Maintenance Application. The Maintenance Application creates a Charge for each NSP tariff by:
flagging if an NSP Tariff contains energy use or not, therefore relevant or not relevant;
recording the energy rate associated to the NSP Tariff;
creating the Charge, Charge ID and associating the NSP Tariff code to the Charge ID;
storing the result for future use during member energy payment processing.

Referring to FIG. 8, the process of creating and distributing invoices for payment by customers is identical in both conventional and Energy Fund processes provided the individual line items in the invoice only contain a single related Charge ID.

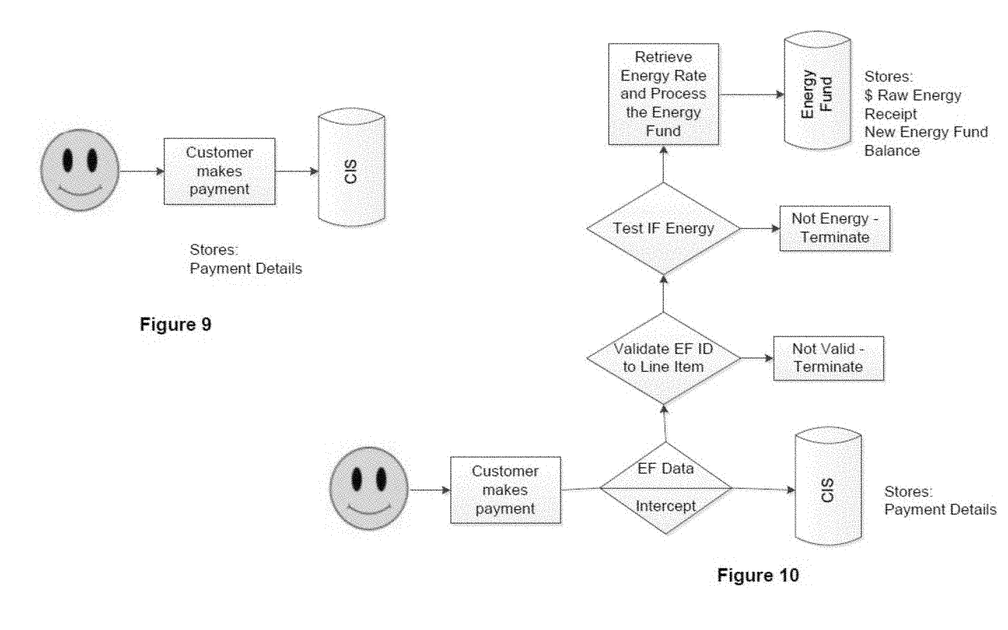

Referring to FIG. 9, in a conventional process the customer payments are received against their account balance to maintain their debit/credit balance. This is also true for the Energy Fund process except it has several additional steps. Referring to FIG. 10, the transaction must be intercepted by the Energy Fund application process, tested for relevance and if relevant, by referencing the related Charge ID, extract the correct value from the transaction and post to the Energy Fund, creating a new Energy Fund balance.

Referring to FIGS. 11 and 12, conventional and Energy Fund payment processes both result in supplier invoice being paid, however the Energy Fund model is more complex in that it must identify the portion of the payment that is due from the Energy Fund. To do this it intercepts the payment, tests that it is relevant, if relevant determines the component that is for Raw Energy and extracts that value from the Energy Fund, combines that value with the balance from a non-Energy Fund account and pays the provider the full invoice. If the invoice or invoice line item was not relevant, then that value would be paid from a non-Energy Fund account.

To provide the Energy Fund application and processes, several components are required beyond a conventional CIS for financial and customer detail management. The additional components or applications of the Energy Fund may include the following.
An application to create, edit, link, ID and store the associated Raw Energy cost associated with each NSP Tariff
An application which intercepts New Member Applications and extracts the Energy Fund Volatility risk management payment component of the transaction and transfers that value to the Energy Fund.
An application which intercepts Member maintenance actions and extracts any Energy Fund Contribution component of the transaction and transfers that value to the Energy Fund.
An application to intercept transactions, determine the relevant transactions and then:
   For Receipts: transfer the correct portion to the Energy Fund by referencing the Charge ID link to the correct charge; or
   For Receipts: transfer the portion to the Energy Fund that is an adjustment of the Energy Fund Contribution; and
   For Invoice Payments: extract the correct portion of invoice payment from the Energy Fund by determining the Raw Energy component of the invoice and add to non-Energy Fund revenues for full payment of the account

The software processes and modules of the Energy Fund may be configured to provide the functionality described below. The CS component simply gives a definition to each NSP “Charge” which enable it to be logically broken up to its various expense components in the Unpacking process. The breakup does not have to be known at the time the customer bill was created however it would put components at risk if it were not as there may be insufficient income generated in the receipts to allow for the CS ultimately determined. The expectation is that the CS is determined each time a new retail value for an NSP “Charge” is calculated by the retailer. The Cost Stack must be known for the Unstacking process. The only important value in the CS is the Predicted Energy Cost as this is the only value transferred to the Energy Fund and is the value that is significant in this patent.

The Cost Stack component may provide the following functionality.
Each NSP has many “Use of system tariffs”
For each “Use of system tariff” the following must be recorded:
   Period applied Start date/time (may be held for the overall NSP periodic schedule)
   Period applied End date/time (may be held for the overall NSP periodic schedule)
Each “Use of system tariff” may have one or more “Charges”
For each “Charge” the following must be recorded:
   Charge type: Day Rate, Energy, Demand
   CS
For each CS the following should be recorded:
   The value of each component for:
      Regulator cost
      NSP cost
      Predicted Day Rate Cost
      Retailer cost
For each CS the following must be recorded:
   The value of each component for:
      Total CS value
      Predicted Energy Cost
Each customer bill must be able to contain:
   Measured usage of one or more relevant “Charges”
   One or more “Use of system Tariff” periods

The Unstacking Process of the Energy Fund may have the following functionality. Those processes typically used for obtaining financial data from a bank or similar entity and importing this into a CIS and correlating an imported record to a customer in the CIS may also be used. The current RE in the NEM and VESC are unlikely to allow Customer contributions to be received into the equivalent of the Energy Fund unless those contributions are isolated in a Trust for the protection of the customers. In the future or through the agency of another RE where approval is given for Customer contributions to be contained in some other financial “entity” then that “entity” will be considered an Energy Fund.

For the Unstacking Process the “Charge” CS must be stored in the application database, integrated to it, available via web services or some other method. The sustainment of the Customer Energy Fund depends on a key item in the proposed CS, being the Predicted Energy Cost. This is the only value to be transferred to the Energy Fund and is the value of significance. While a value is needed for the Predicted Energy Cost, the method used to calculate the Predicted Energy Cost may be any conventional statistical technique. Good management practice would dictate that the other values in the CS are known and dealt with as below.

The Unstacking Process is to provide the following functionality.
Each “Charge” for each “Use of system tariff” period may be broken into:
   Regulator value
   Predicted Day Rate value
   NSP value
   Retailer value
Each “Charge” for each “Use of system tariff” period must be broken into:
   Predicted Energy KWh value
Each Regulator value could be posted to an area for Regulator payment
Each Predicted Energy KWh Value must be posted to the Energy Fund or its equivalent
Each Predicted Day Rate value could be posted to an area for NSP payment
Each NSP value could be posted to an area for NSP payment
Each Retailer value could be posted to an area for Retailer general business use.

The defined process around the Energy Fund must ensure that it receives all relevant payments for acquiring wholesale energy on behalf of the retail customer. This includes any initial or adjusted contributions as well as the Predicted Energy Cost defined in the CS. The Energy Fund management process is to provide the following functionality.
A method to determine periodically the Fund Unit $value as the basis for:
   converting new customer Energy Fund contributions to Fund Units
   converting exiting customer Fund Units back to a $cash value
A method to enable a member of the public to become a customer and provide a contribution to the Energy Fund via either one or all of:
   a public-facing web interface including a funds transfer facility
   a staff-facing interface including an electronic funds transfer facility
On establishment of a new customer, the Energy Fund must:
   receive their contribution equivalent to an agreed rate per/MWh/energy usage/annum;
   convert the $Value into Fund Units;
   allow the customer to exit in the future by converting their Fund Units back into $Value based on the Fund Unit $Value at that time
On receipt of each customer periodic bill payment, receive the Predicted Energy KWh Value
On receipt of an energy acquisition bill the Energy Fund must make available the Energy Only part of the bill for the business to pay
On recognising that a customer has underpaid their initial contribution compared to their actual energy use, the Energy Fund must receive a contribution equivalent to the shortfall of the previously predicted MWh/energy usage/annum

The Business payment process explicitly associated with the Energy Fund requires the following functionality. On receipt of an energy acquisition bill:
Make available funds from the Energy Fund for the Energy Only part of the bill
Pay the bill on time, by combining the Energy Only contribution from the Energy Fund with funds from the Regulator payment area to resolve the entire bill

The example described above places all of the Pool Pre-payments and all of the Predicted Energy Cost into the Prepayment Pool and then paying out the full Raw Energy cost from the Energy Fund. An alternate process would be to receive the Predicted Energy Cost as a part of the stack contained in the invoice paid by the retail customer and apply that directly to any Raw Energy payment and where there is:
a shortfall, provide that short fall from the Energy Fund to complete the full payment for Raw Energy; and
an excess, pay the value in excess of the full Raw Energy payment into the Energy Fund

It will be appreciated that the use of this or similar subtle variations to the surrounding transactions supporting the fundamental purpose of Energy Fund is possible. Further, the above example uses a single Energy Fund but that is not critical. One or more individual Energy Funds could be used for each State or for specific market sectors or at the extreme for one individual customer. It is not the number of customers in the Energy Fund but the use of an Energy Fund itself to manage volatility which is key.

The above example may be used for utility customers as members of an organisation requiring them to pay an annual membership fee to qualify to receive the benefit of the use of the Energy Fund to access wholesale utility product prices. It will be appreciated that the presence or absence of the membership fee, paid annually or at any other period, does not affect the unique nature of the Energy Fund.

Embodiments of the present invention provide a computer-implemented method that is useful for managing volatility risk in variable priced utilities, for example, electricity, gas, or a combination thereof. Embodiments of the invention allow retail consumers to participate in the acquisition of wholesale energy and associated risk through a prepayment pool which protects all participants from the volatility of the energy market while delivering the acquired energy at a reduced cost by avoiding those costs and resources normally associated with existing industry hedging and management methods used to address market volatility. Embodiments of the invention also provide a way of ensuring that funds are available for the energy retailer to manage market risk on behalf of customers in a way that complies with regulatory requirements. Further, embodiments of the invention provide a way for consumers to participate in, and enjoy the benefits of the wholesale energy market at minimal risk, and provide a way of funding at a lower cost to the retail customers than is, for the most part, possible by using other conventional methods.

For the purpose of this specification, the word “comprising” means “including but not limited to,” and the word “comprises” has a corresponding meaning.

The above embodiments have been described by way of example only and modifications are possible within the scope of the claims that follow.

1.-14. (canceled)

15. A method comprising the steps performed by a specially programmed computer of:
receiving a predicted usage by customers of a utility having fixed costs and variable usage prices;
establishing a fund for hedging future volatility risk in the variable usage prices by combining prepaid contributions from the customers based on the predicted usage and a volatility margin to offset the volatility risk;
determining a fixed, predicted usage price for the customers based on historic variable usage prices, forecast variable usage prices, or a combination thereof.

16. The method of claim 15, further comprising the steps of:
receiving wholesale cost stacks for the customers comprising the fixed costs, and actual variable costs based on actual usage by the customers and actual variable usage prices of the utility;
unstacking the wholesale cost stacks to separate the actual variable costs from the fixed costs;
creating retail bills for the customers comprising the fixed costs, and predicted variable costs based on actual or estimated usage by the customers and the predicted usage price of the utility;
receiving retail bill payments for the retail bills comprising fixed cost payments and predicted variable cost payments.

17. The method of claim 16, further comprising the steps of:
paying the predicted variable cost payments in full into the fund;
paying the actual variable costs in full from the fund.

18. The method of claim 17, further comprising the step of paying the fixed costs in full from the fixed cost payments not paid into the fund.

19. The method of claim 16, further comprising the steps of:
if the actual variable costs are greater than the predicted variable costs, paying the actual variable costs in part from the predicted variable cost payments, and paying remaining balances of the actual variable costs from the fund;
if the actual variable costs are less than the predicted variable costs, paying the actual variable costs in full from the predicted variable cost payments, and paying remaining balances of the predicted variable cost payments into the fund.

20. The method of claim 15, wherein the utility comprises electricity, gas or a combination thereof.

21. The method of claim 15, wherein the method is provided to the customers as software-as-a-service.

22. The method of claim 15, further comprising the step of receiving membership fees from the customers to participate in the fund.

23. A non-transitory computer-readable medium comprising computer-readable instructions, wherein execution of the computer-readable instructions by a computer causes the computer to:
receive a predicted usage by customers of a utility having fixed costs and variable usage prices;
establish a fund for hedging future volatility risk in the variable usage prices by combining prepaid contributions from the customers based on the predicted usage and a volatility margin to offset the volatility risk;
determine a fixed, predicted usage price for the customers based on historic variable usage prices, forecast variable usage prices, or a combination thereof.

24. The non-transitory computer-readable medium of claim 23, wherein the computer-readable instructions further cause the computer to:
receive wholesale cost stacks for the customers comprising the fixed costs, and actual variable costs based on actual usage by the customers and actual variable usage prices of the utility;
unstack the wholesale cost stacks to separate the actual variable costs from the fixed costs;
receive retail bill payments for the retail bills comprising fixed cost payments and predicted variable cost payments.

25. The non-transitory computer-readable medium of claim 24, wherein the computer-readable instructions further cause the computer to:
pay the predicted variable cost payments in full into the fund;
pay the actual variable costs in full from the fund.

26. The non-transitory computer-readable medium of claim 25, wherein the computer-readable instructions further cause the computer to pay the fixed costs in full from the fixed cost payments not paid into the fund.

27. The non-transitory computer-readable medium of claim 25, wherein the computer-readable instructions further cause the computer to:
if the actual variable costs are greater than the predicted variable costs, pay the actual variable costs in part from the predicted variable cost payments, and pay remaining balances of the actual variable costs from the fund;
if the actual variable costs are less than the predicted variable costs, pay the actual variable costs in full from the predicted variable cost payments, and pay remaining balances of the predicted variable cost payments into the fund.

28. The non-transitory computer-readable medium of claim 23, wherein the utility comprises electricity, gas or a combination thereof.
